(19) United States
(12) Patent Application Publication
(10) Pub. No.: US 2006/0260927 A1
(43) Pub. Date: Nov. 23, 2006

(54) Apparatus and method for continuous catalytic reactive distillation and on-line regeneration of catalyst

(76) Inventor: Armen Abazajian, Houston, TX (US)

Correspondence Address: Parks & Associates, P.C., Suite 101, 3131 West Alabama, Houston, TX, 77098, US

(21) Appl. No.: 11/132,954

(22) Filed: May 19, 2005

(51) Int. Cl. B01D 3/34

(52) U.S. Cl. 203/29; 203/DIG. 6; 202/158; 422/190; 422/211

(57) ABSTRACT

Apparatus and method for catalytic reactive distillation and on-line regeneration of solid supported catalyst used in the reactive distillation process comprising a distillation column formed into 1^{st} and 2^{nd} functional parts with vapor and fluid connections to 1^{st} and 2^{nd} functional parts and at least one catalytic distillation reactor containing catalyst connected to the vapor and fluid connections and a catalyst regenerator connected to the at least one catalyst distillation reactor for regenerating the catalyst using the method of operating the catalytic distillation reactor to catalyst deactivation and switching communication off to the distillation column and on to the catalyst regenerator for regeneration of catalyst and returning the catalytic distillation reactor to the distillation column.

### FIELD OF INVENTION

This invention relates to apparatus and methods for catalytic reactive distillation and for on-line regeneration of solid supported catalyst used in the reactive distillation process using a distillation column. The distillation column being formed to have at least two functional separated parts therein. Each part of the at least two functional parts of the distillation column has at least one vapor and liquid connection for fluid communication with the 1^{st} functional part of said distillation column and at least one vapor and liquid connection for fluid communication with the at least a functional 2^{nd} part of the distillation column. At least one catalytic distillation reactor containing solid-supported catalyst is connected to the at least one vapor and liquid connections of the 1^{st} and 2^{nd} functional parts of the distillation column for operational catalytic reaction distillation of the products delivered from and returned to the 1^{st} and 2^{nd} functional parts of the distillation column. The lighter products delivered from the catalytic reaction process in the catalytic reactor are fed to the 2^{nd} functional part of the distillation column. The 2^{nd} functional part of the distillation column has a vapor/liquid contacting zone therein for allowing separation of heavier product from the lighter vapors and removal of the light vapor molecules over head at the top of the 2^{nd} functional part of the distillation column. The heavier products delivered from the catalytic distillation reactor are re-reacted or returned to the 1^{st} functional part of the distillation for re-heating in the boiler or removal as final heavier end product. The catalytic distillation reactor has functionally connected to it a catalyst, regenerating member for regenerating the catalyst after the catalyst is deactivated from its time in operation. The solid supported catalyst in the catalytic distillation reactor is continued in operation until the catalyst is deactivated. Once it is deactivated the at least one vapor and liquid connection for fluid communication with the at least a functional 1^{st} and at least a functional 2^{nd} part of the distillation column are switched off and the connection functionally between the catalyst regenerator and the catalytic distillation reactor is switched on to allow the catalyst to be regenerated. Further in some embodiments of the apparatus and method of this invention at least another catalytic distillation reactor containing solid-supported catalyst is also connected to the at least one vapor and liquid connections of the 1^{st} and 2^{nd} functional parts of the distillation column for operational catalytic reaction distillation of the products delivered from and returned to the 1^{st} and 2^{nd} functional parts of the distillation column while the at least one catalytic distillation reactor with the solid supported catalyst is being regenerated the at least another catalytic distillation reactor can be operated. By alternating between the at least one catalytic distillation reactor and the at least another catalytic distillation reactor the distillation column can be kept in continuous operation while the solid supported catalyst is being alternatively used in the process or being regenerated while on line in the distillation column.

### BACKGROUND OF THE INVENTION

It is well known in the prior art that catalysts used to facilitate chemical reactions in reactive catalytic distillation processes generally have a defined limited life in use before they are deactivated by poisonous elements in the feed stock used in the process or, fouled out by build up of coke or un-reactive product on the catalysts, or other causes. This defined limited life of a catalyst can vary in time depending on the catalysts and the process and feedstock and/or the product derived. In some cases the catalyst may have a relatively short life, but it is so inexpensive that it is run in the process until it is deactivated and then disposed of and replaced by new catalysts. In other processes the catalysts used, such as noble or transition metal oxide catalysts supported on ceramic or metal-oxide substrate, are relatively expensive and cannot be disposed of after one use but they are regenerated by a regeneration process after they are deactivated. In fact, such catalysts must be regenerated to make the catalysts commercially viable in the reactive catalytic distillation process. The defined limited life before catalyst becomes deactivated however gets to be important because if the time period to deactivation is too short relative to its active time in the reactive catalytic distillation process it will also be commercially unviable, because of the product produced relative to the deactivation time and therefore its expense before it has to be regenerated is too short to be commercial. Some good catalysts are commercially unusable because of their short life to deactivation.

The regeneration process, as those skilled in the art will be aware, is generally operated at operating conditions, which are extreme relative to the catalytic distillation process conditions at which these catalysts are used. This difference in operating conditions generally means that the catalysts must be removed from the distillation column and taken to a special regeneration process vessel, which has been designed to accommodate these extreme operating conditions. As those skilled in the art will appreciate, the normal distillation column must be especially designed to meet these extreme operating conditions because of other components located in them and this adds significant expense to the cost of the distillation column. For example a normal distillation column will have feed and reflux liquid distributor and a re-boiler vapor distributor and mass transfer and structural internals, such as packing or trays that do not contain catalyst but enhance components separation and most of these components are not normally designed to tolerate the extreme regeneration operating conditions. For example the typical regeneration conditions have a range from 30-1500 degrees F. and pressures from 0.01 to 1000 psia in either inert or severely oxidizing environment. The normal catalytic reactive distillation vessels with all their additional internal components are not designed to accommodate such operating conditions.

While the art has attempted to deal with solving the disparate vapor/liquid traffic issues in distillation columns and reactors by de-coupling the reaction functions from distillation column functions by employing side reactor concepts, there was no attempt to provide any means to recharge such catalysts in the side reactors under the severe conditions which are required for catalyst regeneration. Also, the prior art used side reactor concepts in combination with a column where the vapor flow was unrestricted and then returned the product of the side reactor back to the column and/or drew off the product from the side reactor. Clearly there was no concept of using the side reactor as a catalyst regeneration site. The prior art in these cases just used the conventional wisdom of either taking the side reactor off-stream then removing the catalyst, or some of the other continuous catalyst replacement prior art. Clearly the prior art did not contemplate the use of one or more side reactors as a means for continuous operation of the distillation column and the prior art did not obtain the efficiencies derived from the creation of the separate functioning parts of the distillation column by creating separate functioning area connected with the side reactors or for their continuous operation once a catalyst had become deactivated.

The prior art, obviously has attempted to use various methods to increase the operating time of a catalyst before it was deactivated and had to be regenerated. The longer a catalyst can be run before it requires taking down the catalytic distillation column the more commercially viable is the process. Also the fewer times a catalyst has to be regenerated the less costs associated with the regeneration expense which effectively becomes part of the process costs associated with the production of a product. Because of this desire to extend the life of a catalyst before it is deactivated, the prior art has attempted various ways to extend the life of a catalyst.

Obviously, however, if a catalyst could have its operating life extended continuously without ever being deactivated that would be a preferred situation. To that end many in the prior art attempted to recycle catalyst by continuously removing catalyst from a distillation column reactor and replacing the catalyst with fresh or regenerated which allows continuous operation of the distillation column. Such processes as liquefied catalyst slurries, which are flowed through the distillation reactor have been used for the continuous catalyst replacement to make fresh catalyst continually available. However some catalysts which use ceramic or metal oxide supported catalyst do not lend themselves to such a process because of the very nature of the catalyst and how they are mounted in catalytic distillation reactor.

### OBJECTS OF THIS INVENTION

It is the object of the invention of this apparatus and method to create an improved apparatus and method for its use which allows the use of distillation columns with catalytic distillation reactors to be used on a continuous basis without regard for a relatively short catalyst life cycle to deactivation.

A further object of this invention is to provide the ability to recharge a catalyst by a regeneration process after they have been activated with in the apparatus and not have to remove the catalyst to a special regeneration device. In some embodiments of this apparatus and method the distillation column can be continuously operated even while the regeneration of the catalyst is occurring without shutting down the distillation column.

Also an object of this invention is to regenerate relatively expensive catalyst which are supported on ceramic or metal-oxide supports, such as alkali metals like sodium, rubidium or cesium impregnated on alumina, silica, silica-alumina, zeolite or zirconia associated with isomerization processes and disproportionation catalyst such as rhenium or tungsten.

It is also and object of this invention to make a reactive catalytic distillation process commercially viable even when the time period to catalyst deactivation is relative short making reactive catalytic distillation processes available which have hereto fore been un-commercial because of short catalyst life.

Yet a further object of this invention is to provide reactive catalytic distillation reactors, which can with stand severe regeneration conditions for the regeneration of catalyst for a range of from 30-1500 degrees F. and pressure of from 0.01 to 1000 psia. The severe design of reactive catalytic distillation reactor for catalyst regeneration is achieved without driving up the costs of the distillation column and allows the use of standard components in the distillation column such as feed and reflux liquid distributors and re-boiler vapor distributors and mass transfer and structural internals, such as packing or trays that do not contain catalyst but enhance components separation.

A further synergistic object of this invention is the benefit obtained in the distillation column by its being separated into at least two functioning parts and then having those part connected through the reactive catalytic distillation reactor for obtaining efficiencies in each of the two functioning areas and the reactive catalytic distillation reactors but not serving the functions of side reactors to an open distillation column.

Another object of this invention is to eliminate the limitation for catalyst which have short deactivation life cycles from being used, which opens up whole new process cycles which have not been explored to date.

It is an object to reduce the costs associated with the regeneration expense and therefore reducing the process costs associated with the production of various products.

A further object is to eliminate the need and expense of having to use continuous catalyst slurries for continuous operation of a reactive catalytic distillation reactor in a distillation column, but allow the continuous use of ceramic and metal oxide supported catalysts.

An object of this invention is to continuously process lighter olefins containing hydrocarbons of C₃ to C₅ using isomerizing catalyst in conjunction with disproportionating catalyst in a reactive distillation reactor and extract heavier olefins containing hydrocarbons of C₅ to C₁₄ from the bottom of the distillation column and extract lighter olefins containing hydrocarbons of C₂ to C₄ from the top of the distillation column with minimal down time due to deactivation of the catalysts in the process.

Yet further and additional benefits and improvement of the process of this invention will be appreciated by others skilled in the art and those advantages and benefits of the invention will become apparent to those skilled in the art upon a reading and understanding of the following detailed description and diagrammatic drawings.

### BRIEF DESCRIPTION OF THE DRAWINGS

FIG. 1 is a diagrammatic drawing of an apparatus for catalytic reactive distillation and on-line regeneration of the catalyst

FIG. 2 is a diagrammatic drawing of an apparatus for catalytic reactive distillation and on-line regeneration of the catalyst while continuously operating the distillation column during the regeneration of the catalyst.

FIG. 3 is a diagrammatic drawing of an apparatus for catalytic reactive distillation of olefin containing hydrocarbons of C₃ to C₁₄ and on-line regeneration of isomerizing and disproportionating catalyst while continuously operating the distillation column during the regeneration of the catalyst.

FIG. 4 is a diagrammatic drawing of an apparatus for catalytic reactive distillation and on-line regeneration of the catalyst while continuously operating the distillation column during the regeneration of the catalyst using a chimney stack tray with chimneys.

### DESCRIPTION OF THE PREFERRED EMBODIMENTS

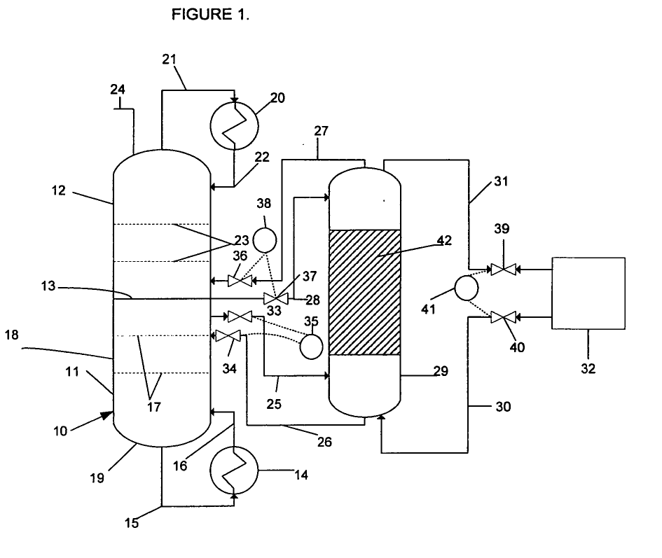

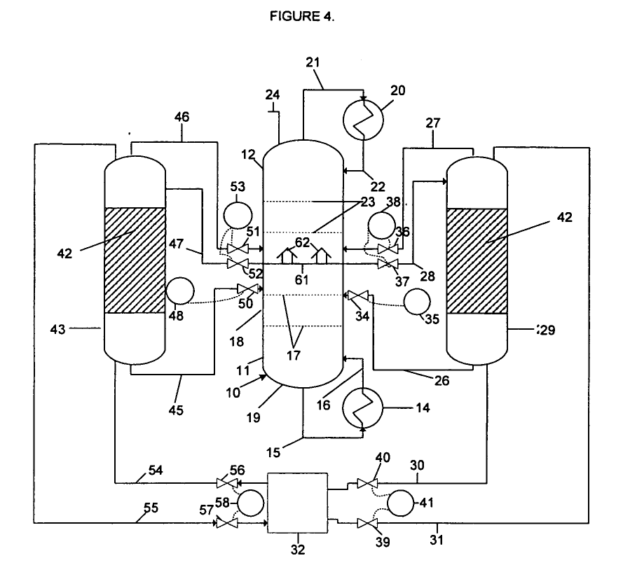

The present invention relates to an apparatus and method for catalytic reactive distillation and for on-line regeneration of solid-supported catalyst used in the reactive distillation process in a catalytic reactive distillation column having a distillation column, generally referred to at reference numeral 10. In at least one embodiment as shown in FIG. 1, the distillation column 10 is functionally divided, even if not physically fully divided, into at least a functional 1^{st} part 11 and at least a functional 2^{nd} part 12 by a partition 13 which may be blind tray or as shown in FIG. 4 chimney stack tray 61 chimney tray or other device to achieve functional and operational separation even if not completely separated or closed off.

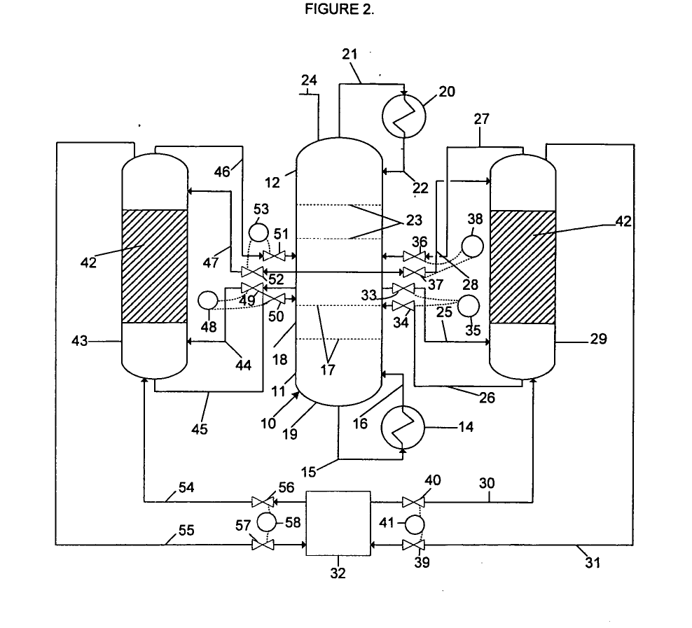

The at least functional 1^{st} part 11 of distillation column 10 is functionally provided with re-boiler 14 as shown in FIG. 1 to feed from and into at least a functional 1^{st} part 11 of the distillation column 10 through a line 15 to the re-boiler 14 and back with a return line 16 to the at least functional 1^{st} part of the distillation column 10 to heat the feed stock for vaporization. As those skilled in the art will appreciate the re-boiler function may be provided by live steam injection or providing at least partially vaporized feed in the at least a functional 1^{st} part 11 of distillation column 10 or in any other way to provide heat for the vaporization of the feed stock to be processed. The at least functional 1^{st} part of distillation column 10 may also have provided, depending on the feed stock to be processed, vapor/liquid contacting equipment 17 positioned in the at least functional 1^{st} part 11 of the distillation column 10. The at least functional 1^{st} part of distillation column 10 may also depending on the product for processing and distillation column design have a product feed port 18 and a product outlet port 19 located therein but the feed port 18 and product outlet port 19 may be located at other locations in the catalytic reactive distillation column apparatus as those skilled in the art would be aware. Also as shown in FIGS. 1 and 2, the at least functional 1^{st} part 11 of the distillation column 10 is connected to the at least one vapor connection 25 and at least one liquid connection 26.

The at least functional 2^{nd} part 12 of distillation column 10 is functionally provided with a condenser 20 which may be feed through vapor line 21 which is connected to the top of the at least functional 2^{nd} part 12 of distillation column 10 for removal of vapors and for their condensation and return through condenser line 22 back to the at least functional 2^{nd} part 12 of distillation column 10. The at least functional 2^{nd} part 12 of distillation column 10 may also have provided, depending on the feed stock to be processed, vapor/liquid contacting equipment 23 positioned in the at least functional 2^{nd} part 12 of the distillation column 10. The at least functional 2^{nd} part 12 of the distillation column 10 may also depending on the product for processing and distillation column design have a lights product outlet 24. Also connected to the at least functional 2^{nd} part 12 of the distillation column 10 is at least one vapor connection 27 and at least one liquid connection 28.

Connected to these at least one vapor connection 25 and at least one liquid connection 26 for fluid communication with the at least functional 1^{st} part 11 of the distillation column 10 is at least one catalytic distillation reactor 29, as shown in FIG. 1. The at least one catalytic distillation reactor 29 is filled with solid-supported catalyst 42 which is appropriate for the product and feed stock being run. Also connected to the at least one catalytic distillation reactor 29, as shown in FIG. 1 are the at least one vapor connection 27 and at least one liquid connection 28 which are also connected to the at least functional 2^{nd} part 12 of the distillation column 10. It can be seen in this embodiment of FIG. 1, that also connected to the at least one catalytic distillation reactor 29 are an incoming regeneration line 30 and outgoing regeneration line 31 which are connected to a catalyst regenerator 32. The outgoing regenerator line 31 may be recycling back through the catalyst regenerator 32 or passing through to a waste stream, not shown. Those skilled in the art will appreciate that a catalyst regeneration process will vary depending on the catalyst and the condition under which it was operated, but in general it is a process of passing oxygen, air, nitrogen, natural gas, steam or any mixture thereof over the catalyst to burn off the coke and poisons accumulated on the catalyst or to volatize the poisons or to otherwise react them away. These regeneration processes occur generally at relative high temperatures of from 30 to 1500 degrees F. and pressures of from 0.01 to 1000 psia and must be run for some period of time depending on the catalyst and how it became deactivated, as those skilled in the art would know.

The at least one catalytic distillation reactor 29, as shown in FIG. 1, is designed as a standard catalytic distillation reactor with solid-supported catalysts 42 held in beds, pockets within structured and unstructured packing, bales, or dispersed throughout the packing and other methods of supporting catalyst in reactive distillation applications known to those skilled in the art. Catalyst 42 or packing supporting the catalyst 42 may be arranged in a single catalytic bed section or consist of several beds or sections with each distinctly separated from each other and having liquid distributors between the bed, but the at least one catalytic distillation reactor 29 of this invention is also of a severe design, for allowing operating conditions for both regeneration of catalyst as well as catalytic distillation operating conditions therein. The severe design of the at least one catalytic distillation reactor 29 means the catalytic reactor 29 is designed for at least allowing operating conditions for both regeneration and catalytic distillation. For the conditions of operating temperatures and pressures to be run therein. These temperatures are in a range of 30 to 1500 degrees F., and these pressures are in a range of 0.01 to 1000 psia, therefore the catalytic reactor 29 is of severe enough design to at least accommodate these ranges, which allows it to serve the function of a catalytic distillation reactor and catalyst regenerator.

To operationally achieve this dual function of catalytic distillation reactor and catalyst regenerator valves 33 and 34 are placed in the at least one vapor connection 25 and at least one liquid connection 26 which are in communication with the at least functional 1^{st} part 11 of distillation column 10 and to communicate with the at least one catalytic distillation reactor 29. These valves are connected to at least one 1^{st} controller 35 for controlled communication of on and off positions of the valves 33 and 34 which affect on and off flow between the distillation column 10 and the at least one catalytic distillation reactor 29. Also valves 36 and 37 are placed in the at least one vapor connection 27 and at least one liquid connection 28 which are in communication with the at least functional 2^{nd} part 11 of distillation column 10 and with the at least one catalytic distillation reactor 29. These valves 36 and 37 are connected to at least one 2^{nd} controller 38 for controlled communication of on and off positions of the valves 36 and 37 which affect on and off flow between the distillation column 10 and the at least one catalytic distillation reactor 29. By activating the at least one 1^{st} controller 35 and at least one 2^{nd} controller 38 the catalytic distillation reactor 29 can be fully functionally connected to flow with the 1^{st} functional part 11 of distillation column 10 and the 2^{nd} functional part 12 of distillation column 10 or be closed off from flow therewith. To complete the dual functionality of the at least one catalytic distillation reactor 29, catalyst regenerator valves 39 and 40 are placed in the at least one outgoing regeneration line 30 and incoming regeneration line 31 of the catalytic regenerator 32 which leads to communication with the at least one catalytic distillation reactor 29. These valves are connected to at least one 3^{rd} controller 41 for controlled communication of on and off positions of the valves 39 and 40 which affect on and off flow between the at least one catalytic regenerator 32 and the at least one catalytic distillation reactor 29. By activating the at least one 3^{rd} controller 41 the catalytic distillation reactor 29 can be fully functionally connected to flow with catalytic regenerator 32 or closed off from flow therewith. Therefore by activating the at least one 1^{st} and 2^{nd} controllers to open valves 33 and 34 and valves 36 and 37 and activating the at least one 3^{rd} controller to close valves 39 and 40 the catalytic distillation reactor 29 can be operated functionally as part of the catalytic reactive distillation apparatus, but when the catalysts 42 in the catalytic distillation reactor 29 becomes deactivated then the at least one 1^{st} and 2^{nd} controllers are activated to close valves 33 and 34 and valves 36 and 37 and activating the at least one 3^{rd} controller to open valves 39 and 40 the catalytic distillation reactor 29 can be operated functionally as part of a catalyst regeneration process for regeneration of the catalyst 42 as on-line regeneration. Once the catalyst 42 has been regenerated the at least one 3^{rd} controller and the at least one 1^{st} and the at least one 2^{nd} controllers are activated in reverse to open valves 33 and 34 and vales 36 and 37 and close valves 39 and 40 to return the at least one catalytic distillation reactor 29 back to the process of catalytic distillation. By the coordinated switching back and forth between regeneration of the catalyst 42 in the at least one catalytic distillation reactor 29 while operating the catalytic reactive distillation process, the catalyst may be regenerated on-line. It will be understood by those skilled in the art that the switching back and forth between the functions of regeneration and catalytic distillation will require other operational controls for efficient operation of this invention to maximize both the catalytic distillation and catalyst regeneration processes but these operational controls are within the skill of those in the art.

In one embodied method of using the catalytic reactive distillation apparatus shown in FIG. 1 a feedstock is fed into the catalytic reactive distillation apparatus at predetermined location in the apparatus, which as shown in FIG. 1 is near the bottom of the distillation column 10, which has been at least functionally separated into at least a first part 11 at the bottom of distillation column 10 and at least a 2^{nd} part 12. It should be understood by those skilled in the art that the feed point could be other places in the apparatus without departing from scope of this invention. For example, feedstock may be fed to the distillation column 10 in any predetermined location to optimize the process of reactive distillation. Furthermore, feedstock may be fed to reactive distillation reactor 29 above, below, or between the beds or sections. Heat is then provided to the column, which as shown in FIG. 1 is a reboiler 14 connected to the at least 1^{st} part 11 at the bottom of distillation column 10 by line 15 and return line 16, to vaporize the feedstock. This vapor in this embodiment is transferred from the at least 1^{st} functionally separated part 11 of the distillation column 10 to the at least one catalytic distillation reactor 29, which contains solid-supported catalyst 42 located therein. The vapors transferred to the at least one catalytic distillation reactor 29 contains liquid transferred into the at least one catalytic distillation reactor from the at least functionally 2^{nd} part 12 of the distillation column 10, partially condenses upon contacting this fluid and the resulting combined liquid is reacted over the catalyst 42 and the heavier liquid is transferred from the bottom of the at least one catalytic distillation reactor 29 back to the at least functionally 1^{st} part 11 of the distillation column 10. In an alternative embodiment as shown in FIG. 4, vapor generated in the at least 1^{st} part 11 is not transferred to the at least one catalyst distillation reactor 20, but is allowed to pass through the at least one partition 13 for separating the distillation column 10 using a chimney stack tray 61 into the at least second part 12 of the distillation column 10 where it is partially condensed by the liquid, mixes with it and is then subsequently transferred to the at least one catalytic distillation reactor 29. The vapor is transferred from the top of the at least one catalytic distillation reactor 29 into the at least functionally 2^{nd} part 12 of the distillation column 10 for further condensation of heavier product liquids and these are transferred back to the at least one catalytic distillation reactor 29 for re-reaction with the catalyst 42. The light vapor products are with drawn from the top of the at least 2^{nd} functional separated part 12 of the distillation column 10. The heavier liquid products are withdrawn from the product outlet port 19 in the at least 1^{st} functional separated part 11 of distillation column 10. The at least one catalytic distillation reactor 29 is operated for a time sufficient until the solid supported catalyst is deactivated. Once the catalysts 42 is deactivated the at least one 1^{st} and 2^{nd} controllers 35 and 38 are switched off for closing off communication between with the at least one vapor and liquid connection to the at least functional 1^{st} and 2^{nd} parts 11 and 12 of the distillation column 10 and then switching the at least one 3^{rd} controller on for communication between the at least one catalytic distillation reactor 29 and the at least one catalytic regenerator 32. Once the at least one catalytic distillation reactor 29 is isolated from communication with the distillation column 10 and connected to the at least one catalytic regenerator 32, regeneration of the solid-supported catalyst 42 in the at least one catalytic distillation 29 occurs. Once the solid support catalyst 42 has been regenerated, then the at least one 3^{rd} controller 41 functionally in communication between the at least one catalytic regenerator 32 and the at least one catalytic distillation reactor 29 is switched off and the at least one 1^{st} and 2^{nd} controller functionally in communication between at least functional parts 11 and 12 of the distillation column 10 and the at least one catalytic distillation reactor 29 are switched back on to return the at least one catalytic distillation reactor 29 back to service in the catalytic distillation process.

In yet another embodiment of this invention, the ability to operationally achieve both the dual functions of catalytic distillation and catalyst regeneration for continuous catalytic reactive distillation without loss of production due to catalyst degeneration is achieved as shown in FIG. 2. In this embodiment as shown in FIG. 2, the apparatus of FIG. 1 is used but has added to it at least another catalytic distillation reactor 43, as shown in FIG. 2. This at least another catalytic distillation reactor 43 is also filled with solid support catalyst 42 appropriate for the product being processed in the distillation column 10 and being the same catalyst as in the at least one catalytic distillation reactor 29. In this embodiment there is also an additional at least another vapor connection 44 or another liquid connection 45 connected to the at least a functional 1^{st} part 11 of the distillation column 10. Also in this embodiment there is further provided at least another vapor connection 46 and at least another liquid connection 47 to at least a functional 2^{nd} part 12 of distillation column 10. These at least another vapor and liquid connection 44 and 45 and 46 and 47 are connected to the at least another catalytic distillation reactor 43. Also as seen in FIG. 2 there are connected to the at least another catalytic distillation reactor 43, at least another incoming regeneration line 54 and at least another outgoing regeneration line 55 which are also connected to the at least one catalyst regenerator 32.

The at least another catalytic distillation reactor 43, as shown in FIG. 2 is also designed as a standard catalytic distillation reactor with solid-supported catalyst 42 held in beds, pockets within structured and unstructured packing, bales, or dispersed throughout the packing and other methods of supporting catalyst in reactive distillation applications know to those skilled in the art. Catalyst or packing supporting the catalyst may be arranged in catalyst beds or sections which hold solid supported catalysts 42 and may be single catalytic bed or consist of several beds with each distinctly separated from each other and having liquid distributors between the beds, but the at least another catalytic distillation reactor 43 is also of a severe design, for allowing operating conditions for both regeneration of catalyst as well as catalytic distillation operating conditions. These ranges of temperature and pressure would be the same as in the at least one catalytic distillation reactor's 29 ranges set out above.

The continuous catalytic reactive distillation and on-line regeneration of catalyst in this embodiment are achieved by alternated and coordinated switching between the at least one and another catalytic distillation reactors 29 and 43 to allow continuous operation of the catalytic reactive distillation in one as continuous solid—support catalyst regeneration occurs in the other, as shown in FIG. 2, and hereinafter explained. To operationally achieve this dual continuous catalytic distillation reaction and catalyst regeneration, a set of at least another vapor connection 44 or another liquid connection 45 are made to the at least functional 1^{st} part 11 of distillation column 10 which leads to communication with the at least another catalytic distillation reactor 43. Valves 49 and 50 are placed in the at least another vapor connection 44 and at another liquid connection 45 and are connected to at least another 1^{st} controller 48 for controlled communication of on and off positions of the valves 49 and 50 between the distillation column 10 and the at least another catalytic distillation reactor 43. Also a set of at least another vapor connection 46 and at least another liquid connection 47 are made to the at least functional 2^{nd} part 12 of distillation column 10 which lead to communication with the at least another distillation reactor 43. Valves 51 and 52 are placed in the at least another vapor connection 46 and at least another liquid connection 47, which are connected to at least another 2^{nd} controller 53 for controlled communication of on and off positions of the valves 51 and 52 between the distillation column 10 and the at least another catalytic distillation reactor 43. By activating the at least another 1^{st} controller 48 and at least another 2^{nd} controller 53 the at least another catalytic distillation reactor 43 can be fully functionally connected to flow with the at least functional 1^{st} part 11 of distillation column 10 and the at least functional 2^{nd} part 12 of distillation column or be closed off from flow therewith. To complete this continuous and dual functionality of the at least another catalytic distillation reactor 43, at least another outgoing regeneration line 55 and at least another incoming regenerator 54 is provided from the catalytic regenerator 32, which leads to communication with the at least another catalytic distillation reactor 43. Valves 56 and 57 are placed in the at least another outgoing regeneration line 55 and incoming regeneration line 54 of the catalytic regenerator 43 which leads to communication with the at least another catalytic distillation reactor 43. These valves are connected to at least another 3^{rd} controller 58 for controlled communication of on and off positions of the valves 56 and 57 which affect on and off flow between the catalytic regenerator 32 and the at least one catalytic distillation reactor 43. By activating the at least another 3^{rd} controller 58 to close valves 56 and 57 the another catalytic distillation reactor 43 can be operated functionally as part of the catalytic reactive distillation process, but when the catalyst 42 in the at least another catalytic distillation reactor 43 becomes deactivated then the at least another 1^{st} and 2^{nd} controllers 48 and 53 are activated to close valves 49 and 50 and valves 51 and 52 and activating the at least another 3^{rd} controller 58 is activated to open valves 56 and 57 for communication to the at least another catalytic distillation reactor 43 can be operated functionally as part of a catalyst regeneration process for regeneration of the catalyst 42 as on-line regeneration. Once the catalyst 42 has been regenerated the at least another 3^{rd} controller 58 and the at least another 1^{st} and 2^{nd} controller 48 and 53 are activated in reverse to open valve 49 and 50 and valves 51 and 52 and close valve 56 and 57 to return the at least another catalytic distillation reactor 43 back to the process of catalytic distillation. By coordinated switching back and forth between the at least one catalytic distillation reactor 29 and the at least another catalytic distillation reactor 43 such that one is being run as a catalytic distillation reactor while the other is being run as a catalytic regenerator and then switching their functionality when the catalyst in one is deactivated and the catalysts in the other has been regenerated a continuous operation of the catalytic reactive distillation column can be maintained while the catalyst is regenerated on-line. As those skilled in the catalyst prior art will appreciate a catalyst must have sufficient life before it is poisoned or deactivated to match the regeneration of the catalyst and allow the operational time for the smooth conversion between the at least one catalytic distillation reactor 29 and the at least another catalytic distillation reactor 43 for such a process can be successful. Depending on whether the catalytic distillation reactor is being kept at catalytic distillation condition on a stand-by basis or whether it is having to be brought up cold the catalyst life on the solid support catalyst must have an operational life of 0.5 to 4.0 hours plus at least as long as until the catalyst is regenerated to make the process of this above described embodiment commercial. However, as those skilled in the prior art would recognize, by the addition of at least another (3^{rd}) catalytic distillation reactor to the catalytic reactive distillation column such that the coordination and switching back and forth from the catalytic distillation and to regeneration of the catalytic distillations reactors occurs between three catalytic distillation reactors, then a catalyst with shorter life before degeneration could be used because of the coordinated switches between the 3 catalytic distillation reactors would leave two catalytic distillation reactors operated in series as catalyst regenerators while the other one was in use as a catalytic distillation reactor.

In another embodied method of using the catalytic reactive distillation apparatus shown in FIG. 2, the catalytic reactive distillation apparatus of FIG. 1 and its method have added to it the method of operating another catalytic distillation reactor 43 connected in communication to the at least functional 1^{st} and 2^{nd} parts 11 and 12 of the distillation column 10, while the solid-support catalyst 42 in the at least one catalytic distillation reactor 29 is being regenerated, for a time at least until the sold supported catalyst 42 is regenerated in the at least one catalytic distillation reactor 29. Once the solid supported catalyst 42 is regenerated, switching of at least one 3^{rd} controller functionally in communication between the at least one catalyst regenerator 32 and the at least one catalytic reactive distillation reactor 29 off to communication would occur. Then switching the at least one 1^{st} and 2 controllers functionally in communication between the at least functional 1^{st} and 2^{nd} parts 11 and 12 of the distillation column 10 and the at least one catalytic distillation reactor 29 on to communication would occur. Next, switching the at least another 1^{st} and 2^{nd} controllers 48 and 53 functionally in communication between the at least functional 1^{st} and 2^{nd} parts 11 and 12 of the distillation column 10 and the at least another catalytic distillation reactor 43 off from communication and switching said at least another 3^{rd} controller functionally connected in communication between the catalysts regenerator 32 and said at least another catalytic distillation reactor 43 on to communication would occur for regenerating the solid supported catalyst 42 in the at least another catalytic distillation reactor 43. Once the solid supported catalyst 42 has been regenerated in the at least another catalytic distillation reactor 43, reverse switching the at least another 3^{rd} controller off to communication with catalytic regenerator 32 and the at least one 1^{st} and 2^{nd} controller off to communication and switching said at least another 1^{st} and 2^{nd} controller on to communication for returning the at least one catalytic distillation reactor back to catalytic regeneration. It will be obvious that by alternating the steps of this method that one catalytic distillation reactor unit will always be in operation with the distillation column and anther catalytic distillation reactor will have its solid supported catalyst being regenerated and ready for when the at least one catalytic distillation reactor's solid supported catalyst is deactivated which will allow the continuous operation of the distillation column and reactivation of solid supported catalyst on-line.

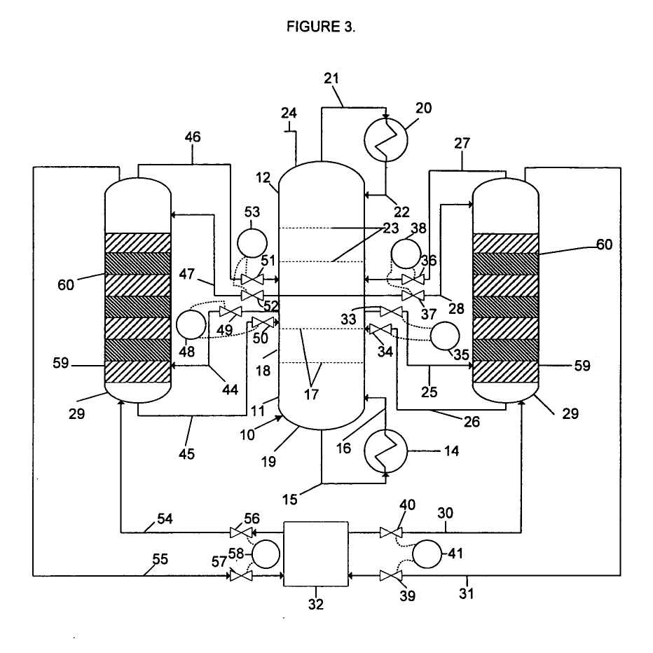

The apparatus and methods used in FIGS. 1 and 2 can also be used with multiple types of catalysts, which by way of example might be layers of catalysts either mixed together or held in separate beds or sections in the catalytic distillation reactor, such as isomerizing catalyst 59 and disproportionating catalysts 60, as shown in FIG. 3. In the embodiment of FIG. 3 the two types of catalyst are shown, by way of example isomerizing catalyst 59 and a disproportionating catalyst 60 as being used, might have different deactivation and regeneration times. While the apparatus of FIG. 3 maybe substantially the same as in FIG. 2 the operational conditions would be slightly different as those skilled in the art will appreciate. For example, the operating time sufficient for catalyst regeneration in the configuration of FIG. 3 would be at least 0.5 to 4.00 hours plus at least as long as until the catalyst with the longest regeneration time is reached because the catalyst used for isomerizing and disproportionating said feed stock would have the catalyst with the longest regeneration time set the time standard for regeneration.

Another embodied variation of the apparatus and methods of FIGS. 1, 2, and 3 can be used, as shown in FIG. 4. In FIG. 4, embodiment the at least one functional separation of the distillation column 10 into at least 1^{st} and 2^{nd} functional parts 11 and 12 is achieved with a chimney stack tray 61. the chimney stack tray 61 serves as a separation of the distillation column into at least 1^{st} and 2^{nd} functional parts but allows the at least one vapor connection 25 of the at least functional 1^{st} part 111 of distillation column 10 shown in FIGS. 1, 2, and 3 to be achieved through the chimneys 62 of the chimney stack tray 61. Since the vapor in the 1^{st} part 11 of the distillation column 10 is allowed to flow through the chimneys 62 of the chimney stack tray 61, which provide the at least one vapor connection for fluid communication with said at least 1^{st} functional part 11 of the distillation column 10, the at least one vapor connection 25 shown in FIGS. 1, 2, and 3 may be eliminated along with the additional elements associated therewith. Similarly, the at least one vapor connection 44 shown in FIGS. 2 and 3 may be eliminated along with the additional elements associated with them. Thus, in the method embodiment of FIG. 4, feedstock is fed into the distillation column 10 and heat is provided by a reboiler 14 to vaporize the feedstock. This vapor is transferred from the at least 1^{st} functionally separated part 11 of the distillation column 10 through the chimney 62 of the chimney stack trays 61 to the at least 2^{nd} part 12 of the distillation column 10 where it is partially condensed in the at least 2^{nd} part 12 of the distillation column 10. These condensed liquids are then transferred by the at least one liquid connection 28 to the catalytic distillation reactor 29, which contains solid supported catalyst 42 located therein and is reacted over the catalyst 42. The heavier liquid is transferred from the bottom of the at least functionally 1^{st} part 11 of the distillation column 10. The vapor is transferred from the top of the at least one catalytic distillation reactor 29 into the at least functionally 2^{nd} part 12 of the distillation column 10 for further condensation of heavier product liquids and these are transferred back to the at least one catalytic distillation reactor 29 for re-reaction with the catalyst 42. The light vapor products are withdrawn from the top of the at least 2^{nd} functional separated part 12 of the distillation column 10. The heavier liquid products are withdrawn from the product outlet port 19 in the at least 1^{st} functional separated part 11 of distillation column 10. The at least one catalytic distillation reactor 29 is operated for a time sufficient until the solid supported catalyst is deactivated. Once the catalyst 42 is deactivated the at least one 1^{st} controller 35 is switched off for closing communication between the at least one liquid connection to the at least functional 1^{st} part 11 of distillation column 10. Simultaneously, the 2^{nd} controller 38 is switched off for closing communication between the at least one vapor and liquid connection to the at least functional 2^{nd} part 12 of the distillation column 10 while then switching the at least one 3^{rd} controller on for communication between the at least one catalytic distillation reactor 29 and the at least one catalytic regenerator 32. Once the at least one catalytic distillation reactor 29 is isolated from communication with the distillation column 10 and connected to the at least one catalytic regenerator 21, regeneration of the solid supported catalyst 42 in the at least one catalytic distillation 29 occurs. Once the solid support catalyst 42 has been regenerated, then the at least one 3^{rd} controller functionally in communication between the at least one catalytic regenerator 32 and the at least one catalytic distillation reactor 29 is switched off and the at least one 1^{st} and 2^{nd} controller functionally in communication between at least functional parts 11 and 12 of the distillation column 10 and the at least 1^{st} and 2^{nd} controller functionally in communication between at least functional parts 11 and 12 of the distillation column 10 and the at lest one catalyst distillation reactor 29 are switched back on to return the at least one catalytic distillation reactor 29 back to service in the catalytic distillation process.

The ability to achieve the dual functions of catalytic distillation and catalyst regeneration for continuous catalytic reactive distillation without loss of production due to catalyst degeneration is achieved in as shown in FIG. 4 in the same manner as shown and described for FIG. 2. However, as shown in FIG. 4 both of the at least one vapor connections 25 and 44 are shown eliminated as the at least one vapor connection of FIG. 4 for fluid communication with the at least one 1^{st} functional part 10 of the distillation column 10 would be achieved through the chimneys 62 which allow the method described above to be alternatively operated for one catalytic distillation reactor as a rector and the other to be operated as a catalyst regenerator unit and then allowing these functions to be switched.

While the preferred embodiments of the invention of this apparatus and process and their operational use have been described for the continuous catalytic reactive distillation and for on-line regeneration of solid-supported catalyst used in the reactive distillation process, it will be appreciated that other embodiments and apparatus and process variables may be used without departing from the spirit of the invention of this process herein claimed.

I claim:

1. An apparatus for catalytic reactive distillation and for on-line regeneration of solid-supported catalyst used in the reactive distillation process comprising;
a. a distillation column,
b. a means for re-boiling,
c. a means for condensing,
d. a means for vapor/liquid contacting,
e. at least one functional separation of said distillation column into at least 1^{st} and 2^{nd} functional parts,
f. at least one vapor connection for fluid communication with said at least 1^{st} functional part of said distillation column,
g. at least one liquid connection for fluid communication with said at least 1^{st} functional part of said distillation column,
h. at least one vapor connection for fluid communication with said at least 2^{nd} functional part of said distillation column,
i. at least one liquid connection for fluid communication with said at least 2^{nd} functional part of said distillation column,
j. at least one catalytic distillation reactor containing solid-supported catalyst in communication with said at least one vapor connection and said at least one liquid connection for fluid communication with said at least 1^{st} and 2^{nd} functional parts of said distillation column, and
k. at least one catalyst regenerating means connected to said at least one catalyst distillation reactor containing solid-supported catalyst for regenerating said catalyst after said catalyst is deactivated.

2. An apparatus for catalytic reactive distillation and for on-line regeneration of solid-supported catalyst used in the reactive distillation process of claim 1 wherein said at least one catalytic distillation reactor further comprises,
a. at least one catalytic distillation reactor of severe design for allowing operating conditions for both regeneration and catalytic distillation to be run therein.

3. An apparatus for catalytic reactive distillation and for on-line regeneration of solid-supported catalyst used in the reactive distillation process of claim 2 wherein said at least one catalytic distillation reactor of severe design further comprises,
a. at least one catalytic distillation reactor containing solid-supported catalyst in communication with said at least one vapor connection and said at least one liquid connection for fluid communication with said at least 1^{st} and 2^{nd} functional parts of said distillation column located outside said distillation column.

4. An apparatus for catalytic reactive distillation and for on-line regeneration of solid-supported catalyst used in the reactive distillation process of claim 3 further comprising;
a. at least another catalytic distillation reactor containing solid-supported catalyst in communication with said at least one vapor connection and said at least one liquid connection for fluid communication with said at least 1^{st} and 2^{nd} functional parts of said distillation column

5. An apparatus for catalytic reactive distillation and for on-line regeneration of solid-supported catalyst used in the reactive distillation process of claim 4 wherein said at least another catalytic distillation reactor further comprises;
a. at least another catalytic distillation reactor of severe design for allowing operating conditions for both regeneration and catalytic distillation to be run therein.

6. An apparatus for catalytic reactive distillation and for on-line regeneration of solid-supported catalyst used in the reactive distillation process of claim 5 wherein said at least another catalytic distillation reactor of severe design further comprises;
a. At least another catalytic distillation reactor containing solid-supported catalyst in communication with said at least one vapor connection and said at least one liquid connection for fluid communication with said at least 1^{st} and 2^{nd} parts of said distillation column located outside said distillation column.

7. An apparatus for catalytic reactive distillation and for on-line regeneration of solid-supported catalyst used in the reactive distillation process of claim 6 wherein at least one functional separation of said distillation column into at least 1^{st} and 2^{nd} functional parts further comprises;
a. at least one partition for separating said distillation column into at least 1^{st} and 2^{nd} functional parts.

8. An apparatus for catalytic reactive distillation and for on-line regeneration of solid-supported catalyst used in the reactive distillation process of claim 7 further comprising;
a. at least one 1^{st} control means functionally connected between said at least one vapor connection and said at least one liquid connection for fluid communication with said at least 1^{st} part of said distillation column for controlled communication on and off between said distillation column and said at least one catalytic distillation reactor,
b. a least one 2^{nd} control means functionally connected between said at least one vapor connection and said at least one liquid connection for fluid communication with said at least 2^{nd} part of said distillation column for controlled communication on and off between said distillation column, and said at least one catalytic distillation reactor, and
c. at least one 3^{rd} control means functionally connected between said at least one catalysts regenerating and said at least one catalytic distillation reactor for controlled communication on and off there between.

9. An apparatus for catalytic reactive distillation and for on-line regeneration of solid-supported catalyst used in the reactive distillation process of claim 8 wherein at least one catalytic distillation reactor of severe design further comprises;
a. at least one catalytic distillation reactor of severe design for allowing operating conditions for both regeneration and catalytic distillation operating temperature conditions in a range of 30 degrees F. to 1500 degrees F. to be run therein.

10. An apparatus for catalytic reactive distillation and for on-line regeneration of solid-supported catalyst used in the reactive distillation process of claim 9 wherein at least one catalytic distillation reactor of severe design further comprises;
a. at least one catalytic distillation reactor of severe design for allowing operating conditions for both regeneration and catalytic distillation operating temperature conditions in a range of 50 degrees F. to 1200 degrees F. to be run therein.

11. An apparatus for catalytic reactive distillation and for on-line regeneration of solid-supported catalyst used in the reactive distillation process of claim 10 wherein at least one catalytic distillation reactor of severe design further comprises;
a. at least one catalytic distillation reactor of severe design for allowing operating conditions for both regeneration and catalytic distillation operating pressure conditions in a range of 0.01 psia to 1000 psia to be run therein.

12. An apparatus for catalytic reactive distillation and for on-line regeneration of solid-supported catalyst used in the reactive distillation process of claim 11 wherein at least one catalytic distillation reactor of severe design further comprises;
a. at least one catalytic distillation reactor of severe design for allowing operating conditions for both regeneration and catalytic distillation operating pressure conditions in a range of 0.10 psia to 500 psia to be run therein.

13. An apparatus for catalytic reactive distillation and for on-line regeneration of solid-supported catalyst used in the reactive distillation process of claim 7 wherein at least one functional separation of said distillation column into at least 1^{st} and 2^{nd} functional parts further comprises;
a. at least one partition for separating said distillation column into at least 1^{st} and 2^{nd} functional parts and for allowing at least one vapor connection for communication therethrough.

14. An apparatus for catalytic reactive distillation and for on-line regeneration of solid-supported catalyst used in the reactive distillation process of claim 13 further comprising;
a. at least one 1st control means functionally connected between said at least one liquid connection for fluid communication with said at least 1st part of said distillation column for controlled communication on and off between said distillation column and said at least one catalytic distillation reactor,
b. at least one 2nd control means functionally connected between said at least one vapor connection and said at least one liquid connection for fluid communication with said at least 2nd part of said distillation column for controlled communication on and off between said distillation column, and said at least one catalytic distillation reactor, and
c. at least one 3rd control means functionally connected between said at least one catalysts regenerating and said at least one catalytic distillation reactor for controlled communication on and off there between.

15. An apparatus for catalytic reactive distillation and for on-line regeneration of solid-supported catalyst used in the reactive distillation process of claim 14 wherein at least one catalytic distillation reactor of severe design further comprises;
a. at least one catalytic distillation reactor of severe design for allowing operating conditions for both regeneration and catalytic distillation operating temperature conditions in a range of 30 degrees F. to 1500 degrees F. to be run therein

16. An apparatus for catalytic reactive distillation and for on-line regeneration of solid-supported catalyst used in the reactive distillation process of claim 15 wherein at least one catalytic distillation reactor of severe design further comprises;
a. at least one catalytic distillation reactor of severe design for allowing operating conditions for both regeneration and catalytic distillation operating temperature conditions in a range of 50 degrees F. to 1200 degrees F. to be run therein.

17. An apparatus for catalytic reactive distillation and for on-line regeneration of solid-supported catalyst used in the reactive distillation process of claim 16 wherein at least one catalytic distillation reactor of severe design further comprises;
a. at least one catalytic distillation reactor of severe design for allowing operating conditions for both regeneration and catalytic distillation operating pressure conditions in a range of 0.01 psia to 1000 psia to be run therein.

18. An apparatus for catalytic reactive distillation and for on-line regeneration of solid-supported catalyst used in the reactive distillation process of claim 17 wherein at least one catalytic distillation reactor of severe design further comprises;
a. at least one catalytic distillation reactor of severe design for allowing operating conditions for both regeneration and catalytic distillation operating pressure conditions in a range of 0.10 psia to 500 psia to be run therein.

19. A method for continuous catalytic reactive distillation and for on-line regeneration of solid supported catalyst using a catalytic reactive distillation apparatus comprising;
a. feeding feed stock to a catalytic reactive distillation apparatus at a predetermined location,
b. providing heat to bottom of a distillation column in said catalytic reactive distillation apparatus by means of a re-boiler,
c. transferring vapor from at least a 1^{st} functionally separated part of said distillation column into said at least one catalytic distillation reactor containing solid-supported catalyst,
d. condensing said vapor transferred from said at least 1^{st} functionally separated part of said distillation column to liquid,
e. reacting said liquid over said solid supported catalyst for forming vapor products and liquid products,
f. transferring liquid products from the bottom of said at least one catalytic distillation reactor to said 1^{st} functionally separated part of said distillation column,
g. transferring vapor products from the top of said at least one catalytic distillation reactor into said 2^{nd} functionally separated part of said distillation column,
h. condensing heavier liquid products from said light vapor products,
i. transferring heavier liquid products from said 2^{nd} functional separated part of said distillation column to said at least one catalytic distillation reactor,
j. withdrawing light products from the top of said 2^{nd} functional separated part of said distillation column,
l. withdrawing heavy products from the bottom of said 1^{st} functional separated part of said distillation column,
m. operating said at least one catalytic distillation reactor for a time sufficient until said solid supported catalyst deactivates,
n. switching at least one 1^{st} and 2^{nd} control means functionally in communication between said at least functionally separated 1^{st} and 2^{nd} parts of distillation column and said at least one catalytic reactive distillation reactor off from communication,
o. switching said at least one 3^{rd} control means functionally in communication between at least one catalysts regenerating means and said at least one catalytic reactive distillation reactor on to communication,
p. regenerating said solid-supported catalyst in said at least one catalytic reactive distillation reactor, and
q. reverse switching steps (n), and (m) for returning said at least one catalytic reactive distillation reactor back to operation for forming a compression seal.

20. A method for continuous catalytic reactive distillation and for on-line regeneration of solid supported catalyst using a catalytic reactive distillation column of claim 19 further comprising;
a. operating another catalytic distillation reactor connected to said distillation column by vapor and liquid connections, while said solid supported catalyst in said at least one catalytic distillation reactor is being regenerated, for a time at least until said catalyst in said at least one catalytic distillation reactor is regenerated,
b. switching at least one 3^{rd} control means functionally in communication between said at least one catalyst regenerating means and said at least one catalytic reactive distillation reactor off to communication
c. switching at least one 1^{st} and 2^{nd} control means functionally in communication between said at least 1^{st} and 2^{nd} functional parts of distillation column and said at least one catalytic distillation on to communication,
d. switching another at least one 1^{st} and 2^{nd} control means functionally in communication between said at least 1^{st} and 2^{nd} functional parts of distillation column and said at least another catalytic distillation reactor off to communication,
e. switching another at least one 3^{rd} control means functionally in communication between said catalysts regenerating means and said at least another catalytic distillation reactor on to communication,
f. regenerating said solid-supported catalyst in said at least another catalytic distillation reactor, and
g. reverse switching steps (e), (d), (c), and (b) for returning said at least another catalytic reactive distillation reactor back to operation and said at least one catalytic distillation reactor back to catalytic regeneration.

21. A method for continuous catalytic reactive distillation and for on-line regeneration of solid supported catalyst using a catalytic reactive distillation column of claim 20 wherein said time sufficient until said catalyst regenerates comprises;
a. an operating time of at least 0.5 hours plus at least as long as until said catalyst is regenerated.

22. A method for continuous catalytic reactive distillation and for on-line regeneration of solid supported catalyst using a catalytic reactive distillation column of claim 21 wherein said time sufficient until said catalyst regenerates comprises;
a. an operating time of at least 4 hours plus at least as long as until said catalyst is regenerated.

23. A method for continuous catalytic reactive distillation and for on-line regeneration of solid supported catalyst using a catalytic reactive distillation column of claim 20 wherein said feedstock comprises;
a. using lighter olefins containing hydrocarbons of C3 to C14.

24. A method for continuous catalytic reactive distillation and for on-line regeneration of solid supported catalyst using a catalytic reactive distillation column of claim 23 wherein said catalyst method comprises;
a. isomerizing said feed stock with a catalyst in said reactive distillation reactor, and
b. disproportionating said feedstock with a catalyst in said reactive distillation reactor.

25. A method for continuous catalytic reactive distillation and for on-line regeneration of solid supported catalyst using a catalytic reactive distillation apparatus comprising;
a. feeding feed stock to a catalytic reactive distillation apparatus at a predetermined location,
b. providing heat to bottom of a distillation column in said catalytic reactive distillation apparatus by means of a re-boiler,
c. transferring vapor from at least a 1^{st} functionally separated part of said distillation column through said at least one partition for separating said distillation column into at least 1^{st} and 2^{nd} functional parts,
d. condensing said vapor transferred from said at least 1^{st} functionally separated part of said distillation column to liquid,
e. transferring said liquid to said solid supported catalyst,
f. reacting said liquid over said solid supported catalyst for forming vapor products and liquid products,
g. transferring liquid products from the bottom of said at least one catalytic distillation reactor to said 1^{st} functionally separated part of said distillation column,
h. transferring vapor products from the top of said at least one catalytic distillation reactor into said 2^{nd} functionally separated part of said distillation column,
i. condensing heavier liquid products from said light vapor products,
j. transferring heavier liquid products from said 2^{nd} functional separated part of said distillation column to said at least one catalytic distillation reactor,
k. withdrawing light products from the top of said 2^{nd} functional separated part of said distillation column,
l. withdrawing heavy products from the bottom of said 1^{st} functional separated part of said distillation column,
m. operating said at least one catalytic distillation reactor for a time sufficient until said solid supported catalyst deactivates,
n. switching at least one 1^{st} and 2^{nd} control means functionally in communication between said at least functionally separated 1^{st} and 2^{nd} parts of distillation column and said at least one catalytic reactive distillation reactor off from communication,
o. switching said at least one 3^{rd} control means functionally in communication between at least one catalysts regenerating means and said at least one catalytic reactive distillation reactor on to communication,
p. regenerating said solid-supported catalyst in said at least one catalytic reactive distillation reactor, and
q. reverse switching steps (o), and (n) for returning said at least one catalytic reactive distillation reactor back to operation.

26. A method for continuous catalytic reactive distillation and for on-line regeneration of solid supported catalyst using a catalytic reactive distillation column of claim 25 further comprising;
a. operating another catalytic distillation reactor connected to said distillation column by vapor and liquid connections, while said solid supported catalyst in said at least one catalytic distillation reactor is being regenerated, for a time at least until said catalyst in said at least one catalytic distillation reactor is regenerated,
b. switching at least one 3^{rd} control means functionally in communication between said at least one catalyst regenerating means and said at least one catalytic reactive distillation reactor off to communication,
c. switching at least one 1^{st} and 2^{nd} control means functionally in communication between said at least 1^{st} and 2^{nd} functional parts of distillation column and said at least one catalytic distillation on to communication,
d. switching another at least one 1^{st} and 2^{nd} control means functionally in communication between said at least 1^{st} and 2^{nd} functional parts of distillation column and said at least another catalytic distillation reactor off to communication,
e. switching another at least one 3^{rd} control means functionally in communication between said catalysts regenerating means and said at least another catalytic distillation reactor on to communication,
f. regenerating said solid-supported catalyst in said at least another catalytic distillation reactor, and
g. reverse switching steps (e), (d), (c), and (b) for returning said at least another catalytic reactive distillation reactor back to operation and said at least one catalytic distillation reactor back to catalytic regeneration.
